(19) United States
(12) Patent Application Publication
(10) Pub. No.: US 2024/0313413 A1
(43) Pub. Date: Sep. 19, 2024

(54) TRI-POLARIZATION RECONFIGURABLE METASURFACE ANTENNA WITH LOW RCS CHARACTERISTICS

(71) Applicant: Nanjing University of Posts and Telecommunications, Nanjing (CN)

(72) Inventors: Feng Xu, Nanjing (CN); Tong Wu, Nanjing (CN)

(21) Appl. No.: 18/515,331

(22) Filed: Nov. 21, 2023

(30) Foreign Application Priority Data
Mar. 17, 2023 (CN) 202310260680.X

(51) Int. Cl. H01Q 15/00; H01Q 1/24; H01Q 21/24

(52) U.S. Cl. CPC H01Q 15/002; H01Q 1/246; H01Q 21/24

(57) ABSTRACT

The invention belongs to the technical field of microwave antenna and discloses a tripolarising reconfigurable metasurface antenna with low RCS characteristics, comprising an upper metasurface metal layer, an upper medium layer, an intermediate metal layer, a lower medium layer and a bottom feeding network metal layer from top to bottom of a rotating phase slot. The upper metasurface metal layer is composed of 4*4 periodic arranged metasurface elements, and the center of each metasurface element is provided with three identical slots obliquely, and the middle metal layer is closely fitted with the upper and lower medium layer. The invention introduces the low RCS characteristic into the traditional polarified reconfigurable antenna and improves the circular polarization bandwidth, so as to increase the availability of the low RCS polarified reconfigurable antenna.

### TECHNICAL FIELD

The present invention belongs to the technical field of microwave antennas, and particularly relates to a tri-polarization reconfigurable metasurface antenna with low RCS characteristics.

### BACKGROUND

The requirements of wireless communication and mobile network for antenna performance are continuously increased. As a terminal of a transmitter and a starting point of electromagnetic wave radiation, the antenna is a cornerstone of the development of wireless communication. After the design of a patch antenna is introduced on a metasurface, great and rapid progress is made.

Metasurface is used as an oscillator with periodically arranged subwavelength having an artificial negative refractive index. Anomalous properties such as negative refractive index make its application widely concerned. In recent years, the research of a metasurface antenna has made great progress: the metasurface can be used as an upper booster amplifier of the antenna, can be integrated with the antenna, and can be used as a radiation patch of the antenna itself to enhance the radiation performance of the antenna. The metasurface as a powerful tool in the new stage of antenna development, and the antenna complement each other and influence each other. In addition, the limitation of the antenna with single polarization performance in the modern communication system leads to the development of polar reconfigurable antennas. Multiple polar reconfigurable antennas generally increase the complexity of an antenna feed network and the number of layers and thickness of a substrate of the antenna, which is not conducive to the design and processing of the polar reconfigurable antennas. Moreover, the addition of too many PIN diodes and MEMS switches may weaken the radiation efficiency of the polar reconfigurable antennas and reduce the stability of in-band gain.

Radar cross section (RCS) represents the scattering quantity of a target object after a target is irradiated by radar waves, and is also the equivalent reflection area reflected by incident waves. The antenna with reduced out-of-band RCS generally exists as a radome of the original antenna, which increases the physical size of the antenna and is not conducive to commonality. The out-of-band frequency selection surface may produce strong reflection for the radar incident waves.

The existing polar reconfigurable metasurface antenna has many disadvantages: 1. The existing polar reconfigurable antenna feed network is relatively complex, and the feed network with too many parameters makes the antenna design and parameter adjustment relatively timeconsuming. 2. The performance of the existing polar reconfigurable antenna is insufficient, and there is no available low-RCS tri-polarization reconfigurable metasurface antenna of the same type. 3. The introduction of too many PIN diodes and MEMS switches in the common polar reconfigurable antenna may change the original performance of the antenna. How to achieve more polarization types with less PIN diodes is the main direction and goal of the reconfigurable antenna at present.

Therefore, a low profile and multipolarization integrated low-RCS antenna with simple feeding mode is urgently needed.

### SUMMARY

To solve the technical problems above, the present invention provides a tri-polarization reconfigurable metasurface antenna with low RCS characteristics. The antenna aims to solve the above shortcomings of the prior works to explore a new tri-polarization reconfigurable metasurface antenna with low RCS characteristics, so as to simplify the feed network design of the polar reconfigurable metasurface antenna; a reflecting layer and a radiating layer of the metasurface antenna are fused, the low RCS characteristics are introduced into the traditional polar reconfigurable antenna, and simultaneously the circular polarization bandwidth is improved, so that the availability of the polar reconfigurable antenna with low RCS characteristics is greatly increased.

To achieve the purpose above, the present invention is realized by the following technical solution:

The present invention is a tri-polarization reconfigurable metasurface antenna with low RCS characteristics. The tri-polarization reconfigurable metasurface antenna comprises an upper metasurface metal layer with rotating phase slots, an upper dielectric layer, a middle metal layer, a lower dielectric layer and a bottom feed network metal layer from top to bottom; the upper metasurface metal layer is composed of 4*4 periodically arranged metasurface units; the center of each metasurface unit is provided with three identical slots obliquely; the slots are uniformly distri-buted in the middle of each metasurface unit, the three slots have no overlap with each other and the spacing between two adjacent slots is equal; four 2*2 metasurface units form a metasurface unit group; four metasurface unit groups are rotatably distri-buted by 90 degrees to form metasurface patterns with overall symmetry about left and right, up and down and oblique 45 degrees; the middle metal layer is arranged between the upper dielectric layer and the lower dielectric layer, and closely fitted with the upper dielectric layer and the lower dielectric layer; and the geometric centers of the upper metasurface metal layer, the middle metal layer and the bottom feed network metal layer are in the same straight line.

The present invention is further improved as follows: the geometric center of the square of the middle metal layer is provided with a cross opening, the feeding energy in three polarization modes is coupled to the upper metacurface metal layer through the cross opening to generate radiation, and the long side of the cross opening is parallel to the side length of an antenna outline.

The bottom feed network metal layer comprises three independently operating ports, three microstrip lines extending to the center and an open ring; the cross opening and the open ring of the middle metal layer are in an overlapped relationship, which is convenient for magnetic coupling; the port energy is introduced into the microstrip lines by impedance matching lines, and finally excited into the 270-degree open ring of the center through PIN diodes; the outer side of the open ring is connected with three independently operating PIN diodes; and the power is fed at 0 degree, 135 degrees and 270 degrees of the open ring respectively to form different electric field propagation modes.

The three PIN diodes have an equivalent resistance of 5.2 ohms in an on state and an equivalent capacitance of 0.025 pF in an off state.

When a port is fed, a DC bias is provided for the corresponding PIN diode on the microstrip of the port to switch the PIN diode to the on state, and the equivalent resistance of the PIN diode in the on state should not be too high. Port 1 and port 2 are symmetric about a 45-degree oblique plane mirror parallel to z axis, so the port 1 and the port 2 achieve a polar operating mode with the same performance indexes and opposite circular polarization rotating directions, wherein when the port 1 is fed separately, the antenna radiates left-handed circularly polarized waves; When the port 2 is fed separately, the antenna radiates right-handed circularly polarized waves, which greatly simplifies the complicated feed network design process of the traditional polar reconfigurable antenna.

When a port is operated, the insertion loss of the other ports is completely controlled by PIN diode disconnection and is less than −20 dB. When port 3 is fed, the antenna is operated in an online polarization mode. At this time, the open ring is left-right symmetrical relative to the feeding position of the port 3, similar to the Wilkinson power divider structure, and the intensity and phase of circular arc electric fields on both sides of the open ring are consistent, so linearly polarized waves are formed.

Three reconfigurable polarization modes are specifically:
When the PIN diode 1 is conducted and the PIN diodes 2 and 3 are disconnected, the port 1 is fed to generate left-handed circularly polarized waves;
When the PIN diode 2 is conducted and the PIN diodes 1 and 3 are disconnected, the port 2 is fed to generate right-handed circularly polarized waves;
When the PIN diode 3 is conducted and the PIN diodes 1 and 2 are disconnected, the port 3 is fed to generate linearly polarized waves.

The microstrip in which each PIN diode is located is consistent with the gap width of the open ring. At the gap, the microstrip is completely separated from the feed structure of the open loop, and only the PIN diodes control the on-off.

The present invention has the following beneficial effects:

The tri-polarization reconfigurable metasurface antenna with low RCS characteristics in the present invention fills the gap of the polar reconfigurable metasurface antenna in the field of radar stealth.

Compared with the traditional polar reconfigurable antenna, the present invention simplifies the feed network design process, and uses a reusable feed network to achieve the circular polarization bandwidth that exceeds the traditional polar reconfigurable antenna. Moreover, the feed network with simple structure reduces the use of the PIN diodes and micro and nano-devices, which is very beneficial for reducing the cross polarization during antenna radiation, has lower interference to the main polarization, and improves the efficiency of the main polarization radiation.

The present invention innovatively fuses the radiating layer and the reflecting layer of the low RCS antenna, introduces three incident wave resonance points at the out-of-band high frequency through 3*16 slots on the metasurface metal layer, and realizes considerable 6 dB single-station RCS reduction at the expense of less in-band radiation gain of the antenna.

Compared with the traditional low RCS antenna, the present invention saves profile height and radiation surface area, so that the present invention has lower section and smaller size, and is easy to be conformal for targets such as airplane.

### DESCRIPTION OF DRAWINGS

FIG. 1 is an exploded structural schematic diagram of a reconfigurable metasurface antenna of the present invention.

FIG. 2 is a top view of a reconfigurable metasurface antenna of the present invention.

FIG. 3 is an S-parameter diagram of left-handed circular polarization in port 1 feed in a reconfigurable metasurface antenna of the present invention.

FIG. 4 is an S-parameter diagram of right-handed circular polarization in port 2 feed in a reconfigurable metasurface antenna of the present invention.

FIG. 5 is an S-parameter diagram of 45-degree linear polarization in port 3 feed in a reconfigurable metasurface antenna of the present invention.

FIG. 6 is a RCS diagram of a reconfigurable metasurface antenna of the present invention outside the working bandwidth and a reference slot antenna.

FIG. 7 is an axial ratio curve chart of left-handed and right-handed circular polarization of a reconfigurable metasurface antenna of the present invention.

FIG. 8 is a gain-frequency change curve chart of three polarization modes of a reconfigurable metasurface antenna of the present invention.

FIG. 9 is a direction diagram of left-handed circular polarization in port 1 feed in a reconfigurable metasurface antenna of the present invention.

FIG. 10 is a direction diagram of right-handed circular polarization in port 2 feed in a reconfigurable metasurface antenna of the present invention.

FIG. 11 is a direction diagram of 45-degree linear polarization in port 3 feed in a reconfigurable metasurface antenna of the present invention.

FIG. 12 is a bottom view of a reconfigurable metasurface antenna of the present invention.

### DETAILED DESCRIPTION

The embodiments of the present invention are disclosed schematically below, and for the purpose of clarity, many practical details are described together in the following illustration. However, it should be understood that these practical details should not be used to limit the present invention. That is, in some embodiments of the present invention, these practical details are not necessary.

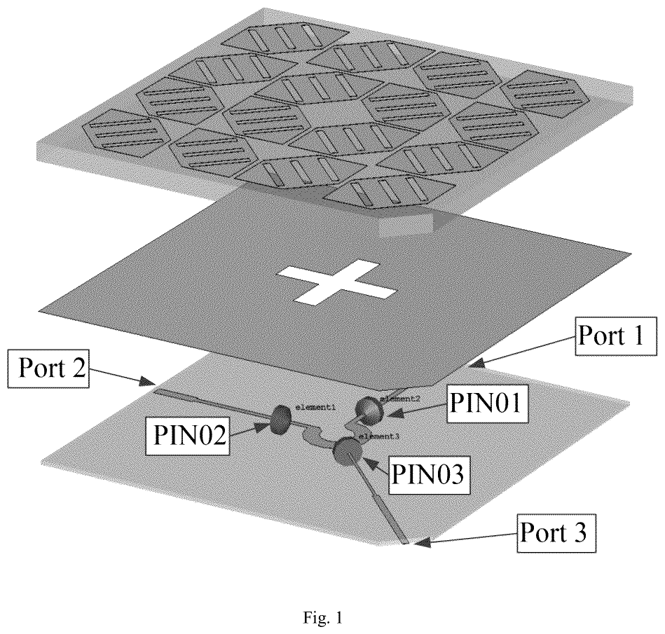

As shown in FIG. 1, the present invention is a tri-polarization reconfigurable metasurface antenna with low RCS characteristics, which is mainly composed of three metal layers and two dielectric layers of different materials, specifically: comprising an upper metasurface metal layer with rotating phase slots, an upper dielectric layer, a middle metal layer, a lower dielectric layer and a bottom feed network metal layer from top to bottom.

The upper dielectric layer is preferably an FR-4 substrate with a thickness of 3.5 mm, having a dielectric constant of 4.3 and a loss angle tangent of 0.025. The lower dielectric layer is preferably a RO4003C substrate with a thickness of 0.813 mm, having a dielectric constant of 3.55 and a loss angle tangent of 0.0027. The geometric center of the square of the middle metal layer is provided with a cross opening, which is convenient for the feeding energy in three polarization modes to coupling to the upper metacurface metal layer through the cross opening to generate radiation; the middle metal layer is closely fitted between the upper dielectric layer and the lower dielectric layer to achieve no any contact with the upper metasurface metal layer and the lower feed network metal layer; the spacing from the upper metal layer to the lower metal layer is always kept as the thickness of the upper dielectric layer; and the spacing from the lower metal feed network layer to the upper metal layer is always kept as the thickness of the lower dielectric layer.

The slot length of the cross opening is less than half of the side length of the square, and the slot width of the cross opening is not greater than the outer diameter of the center open ring of the bottom feed network metal layer. The length of the cross opening is 22 mm and the width is 4.5 mm. The upper dielectric layer, the middle metal layer and the lower dielectric layer are provided with tangential angles, and the antenna is a pentagon with a low profile structure. The tangential angles are consistent with the outlines of the upper and lower dielectric plates.

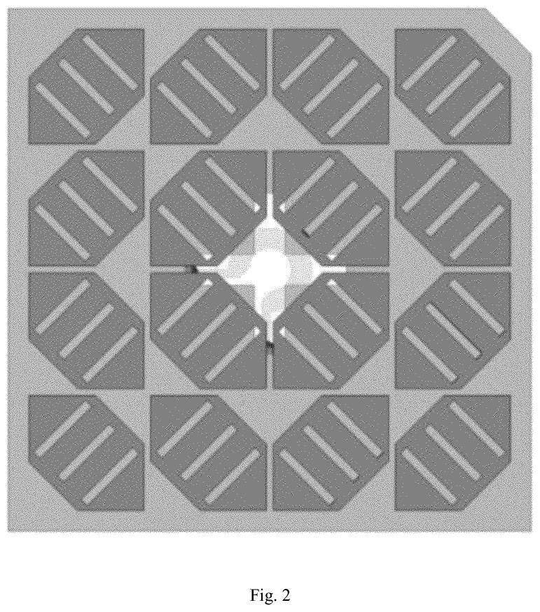

As shown in FIG. 2, the upper metasurface metal layer is composed of 4*4 periodically arranged metasurface units. Each metasurface unit is composed of a tangential square with a side length of 16.5 mm and a tangential width of 9.9 mm, and a gap between the metasurface units is 0.9 mm. The side length of the square where the outline of the tri-polarization reconfigurable metasurface antenna is located is not less than 75 mm. The upper right corner of the top view has a 45° oblique tangential angle, and the width at the tangential angle is not more than 10 mm, and does not coincide with metasurface unit patches.

The center of each metasurface unit is obliquely provided with three identical slots; and the slots can decompose the incident wave into scattered waves in each reflection direction, thereby achieving low RCS design. The three slots have a length of 10.5 mm and a width of 1.3 mm, and the spacing between two adjacent slots is 3.5 mm. The slots are evenly distri-buted in the middle of each metasurface unit, the three slots have no overlap with each other and the spacing between the two adjacent grooves is equal; four 2*2 metasurface units form a metasurface unit group; four metasurface unit groups are rotatably distri-buted by 90 degrees to form metasurface patterns with overall symmetry about left and right, up and down and oblique 45 degrees; and the middle metal layer is located between the upper dielectric layer and the lower dielectric layer and closely fitted with the upper dielectric layer and the lower dielectric layer. The geometric centers of the upper metasurface metal layer, the middle metal layer and the bottom feed network metal layer are in the same straight line.

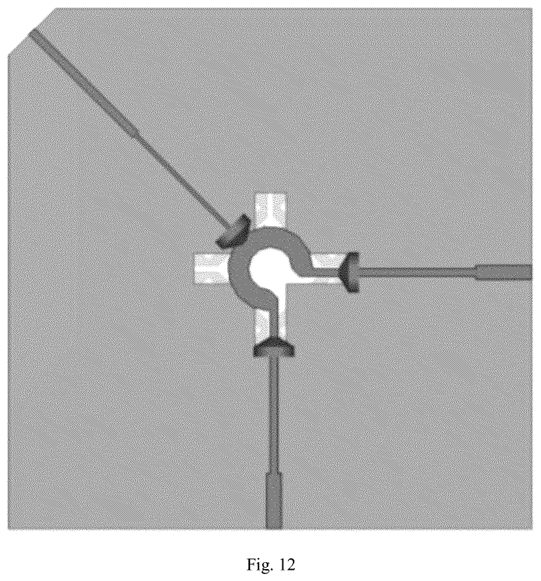

As shown in FIG. 12, the bottom feed network metal layer comprises three independently operating ports, three microstrip lines extending to the center and an open ring. When the three ports are fed respectively, three polarization modes are formed, and different polarization modes are suitable for different communication scenarios. The cross opening and the open ring of the middle metal layer are in an overlapped relationship on the top view, which is convenient for magnetic coupling; the port energy is introduced into the microstrip lines by impedance matching lines, and finally excited into the 270-degree open ring of the center through PIN diodes; the outer side of the open ring is connected with three independently operating PIN diodes; and the power is fed at 0 degree, 135 degrees and 270 degrees of the open ring respectively to form different electric field propagation modes. The feeding energy in three polarization modes is coupled to the upper metacurface metal layer through the cross opening to generate radiation, and the long side of the cross opening is parallel to the side length of an antenna outline.

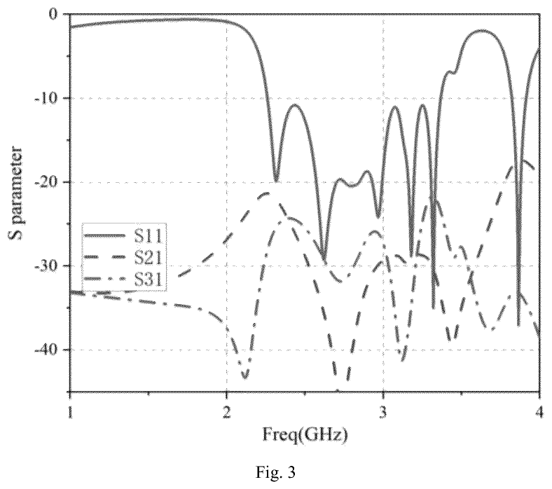

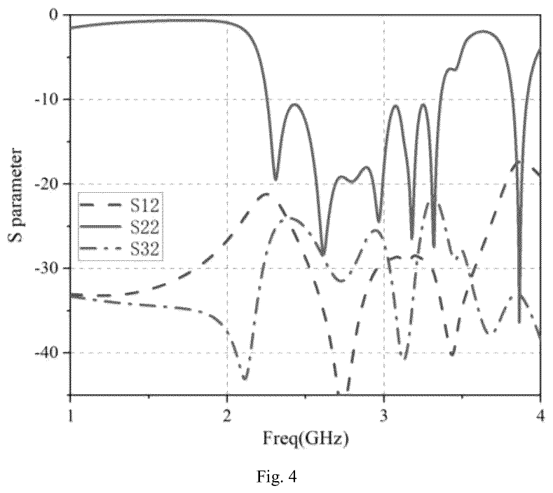

FIG. 3 and FIG. 4 are S-parameter curve charts of port 1 and port 2 which are fed in the operating mode of circular polarization. Because the port 1 and the port 2 are designed as mirror images in the geometric structure, the performance is exactly the same. FIG. 3 is selected for analysis below, and FIG. 4 is the same. In FIG. 3, the matching bandwidth of return loss reaches 41%(2.2 GHZ-3.35 GHZ). Due to the isolation effect of PIN diode disconnection in the feed network, the operating bandwidths of S21 and S31 are lower than −20 dB, and the three-port feed network has excellent port isolation.

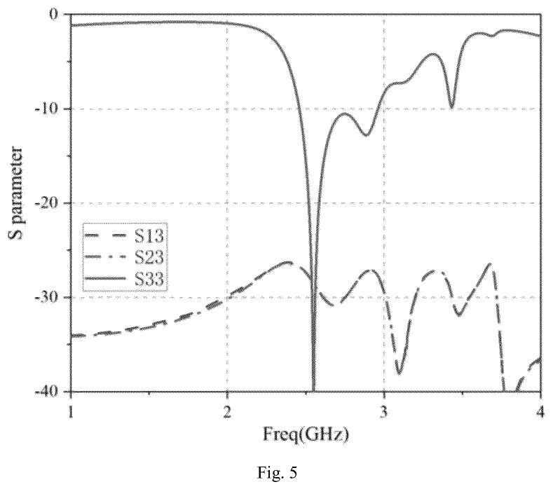

FIG. 5 is an S-parameter diagram when the three-port feed is linearly polarized, and the matching bandwidth of return loss reaches 20%(2.42 GHZ-2.99 GHZ). At the same time, the maximum values of S23 and S13 do not exceed −25 dB, which fully meets the requirements of feed network isolation.

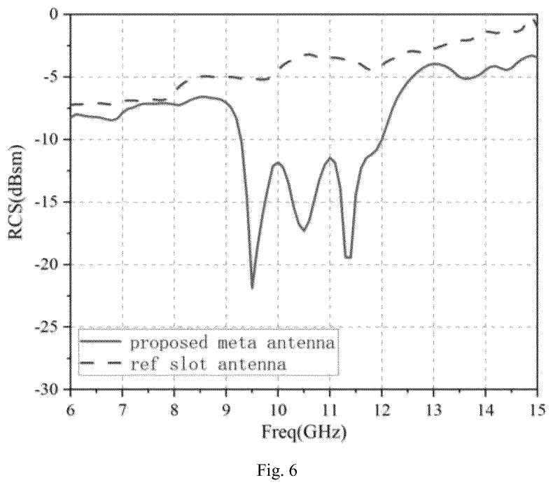

FIG. 6 shows comparison between the RCS curves of a reference antenna (slot antenna) and the present invention. According to FIG. 6, the −6 dB bandwidth of the RCS reduction reaches 24%(9.35 GHz-11.9 GHZ), and three resonant points are introduced out of band to achieve the low RCS characteristics of broadband.

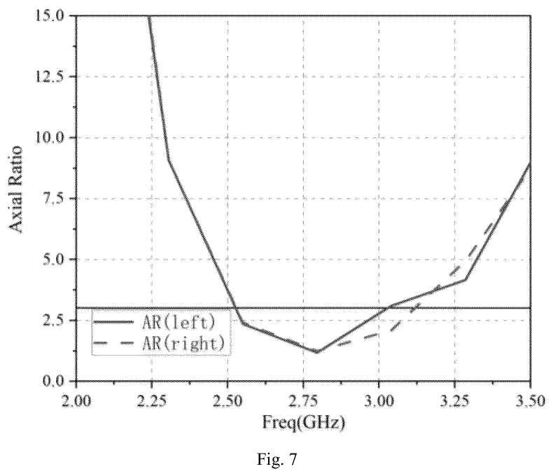

FIG. 7 shows the axial ratio bandwidth for left-handed and right-handed circular polarization. The port 1 is fed, and the axial ratio bandwidth for left-handed circular polarization is 18%. The port 2 is fed, and the axial ratio bandwidth for right-handed circular polarization is 20.2%. The above bandwidths are included in the matching bandwidth in the return loss of the corresponding port, so the operating bandwidth of left-handed circular polarization is 18%, and the operating bandwidth of right-handed circular polarization is 20.2% in the present embodiment.

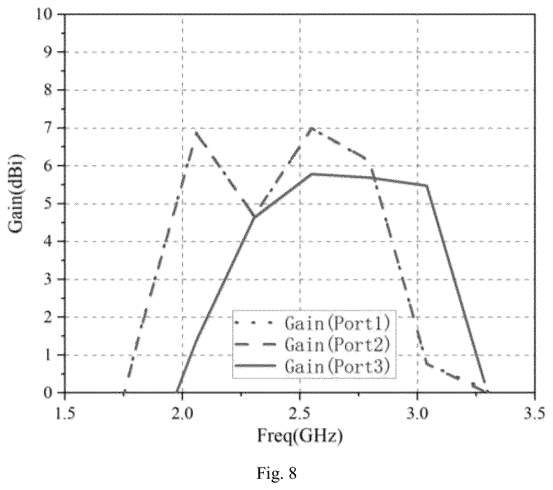

According to FIG. 8, the maximum gain is about 7 dBi when the antenna is operated in the circular polarization mode, and the maximum gain is 5.8 dBi when the antenna is operated in the online polarization mode. The gain flatness in the operating bandwidth is good.

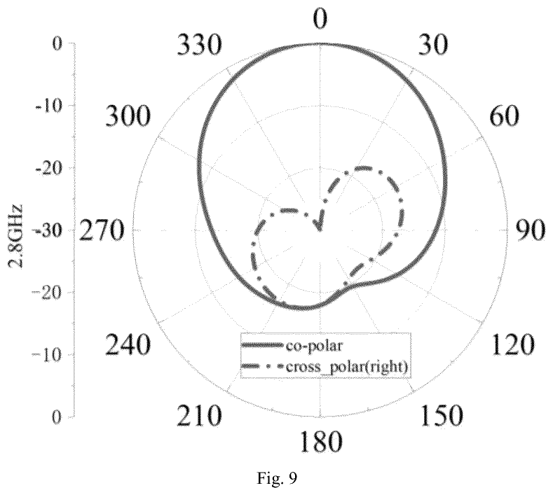

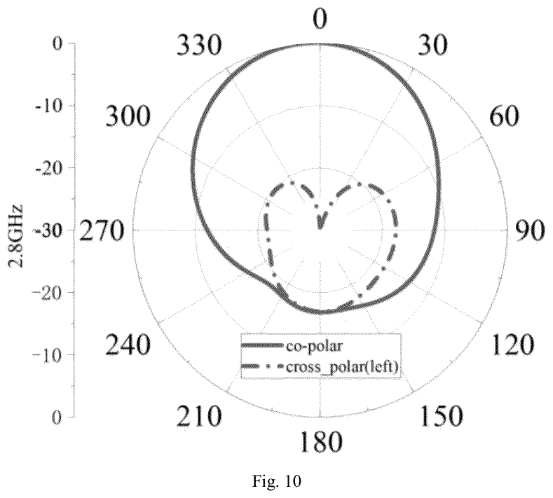

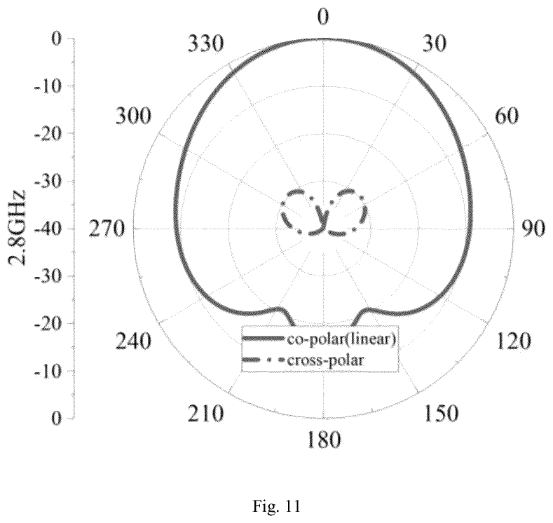

FIG. 9, FIG. 10 and FIG. 11 are direction diagrams at 2.8 GHz when port 3 is fed respectively, including main polarization, i.e., left-handed and right-handed, linear polarization and cross polarization. It can be seen that the cross polarization is always less than −20 dB in the main polarization direction, the polarization purity of the antenna is good in each operating mode, and the main directions of three polarization gains radiate forward along the wide edge.

The present invention uses a multiplexed 270-degree open ring coupling feeding mode to feed three ports at different positions respectively to achieve different antenna polarization modes, and generates good port isolation by controlling the status of the PIN diodes of the feed network layer. When the port 1 and the port 2 are fed separately, two circularly polarized radiation modes with opposite rotating directions are generated. When the port 3 is fed separately, the antenna radiates 45 degrees of linearly polarized waves. The metasurface unit adopts the rotating phase 4*4 low-RCS three-slot structure above the antenna feed network, and the scattering layer of the traditional low-RCS structure is integrated with the metasurface radiating layer of the antenna to achieve a low profile structure while ensuring the radiation performance of the antenna.

The present invention combines the polar reconfigurable structure with the low-RCS structure to simplify the complicated feed network of the common polar reconfigurable antenna. The present invention has important application prospects in the aspect of airborne radar stealth antennas due to the characteristics of multiple polar reconfiguration and low RCS.

The above only describes the embodiments of the present invention and is not intended to limit the present invention. For those skilled in the art, various variations and changes can be made to the present invention. Any modification, equivalent replacement, improvement, etc. made within the spirit and the principle of the present invention shall be included within the scope of claims of the present invention.

1. A tri-polarization reconfigurable metasurface antenna with low RCS characteristics, wherein the tri-polarization reconfigurable metasurface antenna comprises an upper metasurface metal layer with rotating phase slots, an upper dielectric layer, a middle metal layer, a lower dielectric layer and a bottom feed network metal layer from top to bottom; the upper metasurface metal layer is composed of 4*4 periodically arranged metasurface units; the center of each metasurface unit is provided with three identical slots obliquely; the slots are uniformly distri-buted in the middle of each metasurface unit, the three slots have no overlap with each other and the spacing between two adjacent slots is equal; four 2*2 metasurface units form a metasurface unit group; four metasurface unit groups are rotatably distri-buted by 90 degrees to form metasurface patterns with overall symmetry about left and right, up and down and oblique 45 degrees; the middle metal layer is arranged between the upper dielectric layer and the lower dielectric layer, and closely fitted with the upper dielectric layer and the lower dielectric layer; and the geometric centers of the upper metasurface metal layer, the middle metal layer and the bottom feed network metal layer are in the same straight line.

2. The tri-polarization reconfigurable metasurface antenna with low RCS characteristics according to claim 1, wherein the geometric center of the square of the middle metal layer is provided with a cross opening, the feeding energy in three polarization modes is coupled to the upper metacurface metal layer through the cross opening to generate radiation, and the long side of the cross opening is parallel to the side length of an antenna outline.

3. The tri-polarization reconfigurable metasurface antenna with low RCS characteristics according to claim 1, wherein the bottom feed network metal layer comprises three independently operating ports, three microstrip lines extending to the center and an open ring; the port energy is introduced into the microstrip lines by impedance matching lines, and finally excited into the 270-degree open ring of the center through PIN diodes; the outer side of the open ring is connected with three independently operating PIN diodes; and the power is fed at 0 degree, 135 degrees and 270 degrees of the open ring respectively to form different electric field propagation modes.

4. The tri-polarization reconfigurable metasurface antenna with low RCS characteristics according to claim 3, wherein the three PIN diodes have an equivalent resistance of 5.2Ω in an on state and an equivalent capacitance of 0.025 pF in an off state.

5. The tri-polarization reconfigurable metasurface antenna with low RCS characteristics according to claim 3, wherein when one of the ports is operated, a DC bias is added to the PIN diode on the microstrip line where the port is located to conduct the PIN diode, and the other two PIN diodes are kept in an off state; the energy is restrained on the open ring in the center, and polarized waves are generated through upward magnetic coupling of the metasurface layer to form the polar reconfigurable antenna.

6. The tri-polarization reconfigurable metasurface antenna with low RCS characteristics according to claim 1, wherein the unit area of the remaining metasurface units after slotting shall not be less than two-thirds of the area of the square where the metasurface units are located.

7. The tri-polarization reconfigurable metasurface antenna with low RCS characteristics according to claim 6, wherein each metasurface unit is composed of a tangential square with a side length of 16.5 mm and a tangential width of 9.9 mm, and a gap between the metasurface units is 0.9 mm.

8. The tri-polarization reconfigurable metasurface antenna with low RCS characteristics according to claim 7, wherein the length of the three slots is 10.5 mm, the width is 1.3 mm, and the spacing between two adjacent slots is 3.5 mm.

9. The tri-polarization reconfigurable metasurface antenna with low RCS characteristics according to claim 1, wherein the upper dielectric layer, the middle metal layer and the lower dielectric layer are provided with tangential angles, and the antenna is a pentagon with a low profile structure.
